(19) United States
(12) Patent Application Publication
(10) Pub. No.: US 2013/0030117 A1
(43) Pub. Date: Jan. 31, 2013

(54) METHOD OF MANUFACTURING POLYAMIDE AND CARBON NANOTUBE COMPOSITE USING HIGH SHEARING PROCESS

(71) Applicants: Kyong Hwa Song, Seoul (KR); Do Suck Han, Seongnam (KR); Chi Hoon Choi, Suwon (KR); Chan Choi, Seoul (KR); Myung-Hwan Lee, Gumi (KR); Sang-Tae Lee, Gyeonggi-do (KR)

(72) Inventors: Kyong Hwa Song, Seoul (KR); Do Suck Han, Seongnam (KR); Chi Hoon Choi, Suwon (KR); Chan Choi, Seoul (KR); Myung-Hwan Lee, Gumi (KR); Sang-Tae Lee, Gyeonggi-do (KR)

(73) Assignees: GEMANKOREA CO., LTD., Hwaseong (KR); HYUNDAI MOTOR COMPANY, Seoul (KR)

(21) Appl. No.: 13/293,314

(22) Filed: Nov. 10, 2011

(30) Foreign Application Priority Data
Jul. 27, 2011 (KR) 10-2011-0074747

(51) Int. Cl. C08L 77/00; B82Y 30/00

(52) U.S. Cl. 524/606; 977/752; 977/750; 977/753

(57) ABSTRACT

The present invention provides a method of manufacturing polyamide-carbon nanotube composites. The method includes mixing a polyamide composition including 0.01-1% by weight of carbon nanotubes using a shearing rate equal to or greater than 1000-4400 sec⁻¹.

### CROSS-REFERENCE TO RELATED APPLICATION

This application claims the benefit of Korean Patent Application No. 10-2011-0074747, filed Jul. 27, 2011, under 35 U.S.C. §119(a). The entire contents of the aforementioned application are incorporated herein by reference.

### BACKGROUND

(a) Technical Field

The present invention relates to a polyamide composition for manufacturing a polyamide/carbon nanotube composite and a method for manufacturing the same.

(b) Background Art

As one of the most useful engineering plastic resins, polyamide has excellent properties such as fatigue-resistance, impact-resistance, wear-resistance, and chemical-resistance, and thus has been used to manufacture a variety of products such as gears, connectors, safety belt clips, safety helmets, hydraulic hoses, outdoor chairs, engine covers, etc., in the electric industry, the electronic industry, the automobile industry, the household products industry, etc. In order to provide high-functional properties to the polyamide resin, recent research has been directed towards synthesizing the resins using various methods such as chemical reforming, adding various inorganic materials to the resin, mixing with other resins, or monomer modification in polymerization process.

The carbon nanotube, one of the reinforcing materials for various resins, has amazing properties, such as high thermal/electric conductivity, and high tensile strength (in some cases over 100 times that of steel). Another advantage of the carbon includes the weight, which is only about ⅙ that of steel. Therefore, much research has been devoted to improving resins by applying carbon nanotubes.

A drawback of carbon nanotubes is found in that that they cannot be mixed effectively with the resins because the nanotubes entangle themselves very easily by static electricity, van der Waaals forces, and the like. In order to improve the dispersibility of the carbon nanotubes, a number of method have been suggested, such as manufacturing nano composites in a polymerizing process, pre-treating the carbon nanotubes, wrapping the carbon nanotubes with a proper resin, and the like. Specifically, Korean Patent Application No. 10-2003-0034824 discloses a method of manufacturing nano composites using a condensation method, and Korean Patent Application No 10-2008-0047508 discloses a method of manufacturing a pre-composite by allowing the carbon nanotube to contact plasticizer. In addition, Korean Patent Application No. 10-2003-0058240 discloses a dispersing method by using dispersants and ultrasonic waves. The drawbacks of these methods include complicated process steps, low productivity, and high manufacturing cost.

The most common and usual method for improving the property of the resin is by making composite material by dispersing pre-treated carbon nanotubes in the molten resin. However, as described above, the pre-treatment of the carbon nanotubes is complicated and time-consuming. Therefore, this method cannot be applied to mass-production.

### SUMMARY OF THE DISCLOSURE

In one aspect, the present invention provides a method of manufacturing polyamide-carbon nanotube composites, the method comprising: mixing a polyamide composition with carbon nanotubes to form a mixed composition; wherein the carbon nanotubes comprise about 0.01% to about 1% weight of the mixed composition; wherein the mixing is performed at a shearing rate ranging from about 1,000 to about 4,400 sec⁻¹.

In an exemplary embodiment, the carbon nanotube comprises a multi wall carbon nanotube, a single wall carbon nanotube, or a carbon nanofiber, or mixtures thereof.

In another exemplary embodiment, the mixing of the polyamide composition may be performed for about 5 seconds to about 100 seconds.

In still another exemplary embodiment, the mixing of the polyamide composition may be performed at a temperature of about 220° C. to about 280° C.

In another embodiment, the polyamide is polyamide6.

In another aspect, the present invention provides a polyamide-carbon nanotube composite manufactured by the above-described methods.

Other aspects and exemplary embodiments of the invention are discussed infra.

### BRIEF DESCRIPTION OF THE DRAWINGS

The above and other features of the present invention will now be described in detail with reference to certain exemplary embodiments thereof. The drawings are meant for illustration purposes only, and at not meant to limit the invention.

FIG. 1 is a schematic view of a high shearing apparatus that can be used to realize a method of manufacturing a polyamide composite according to an exemplary embodiment of the present invention; and

FIG. 2 is a SEM picture showing a dispersion state of the carbon nanotubes after a mixture of polyamide6 and a multi wall carbon nanotubes is processed in low shear rate (left side, 440 sec⁻¹) and high shear rate (right side, 4400 sec⁻¹).

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

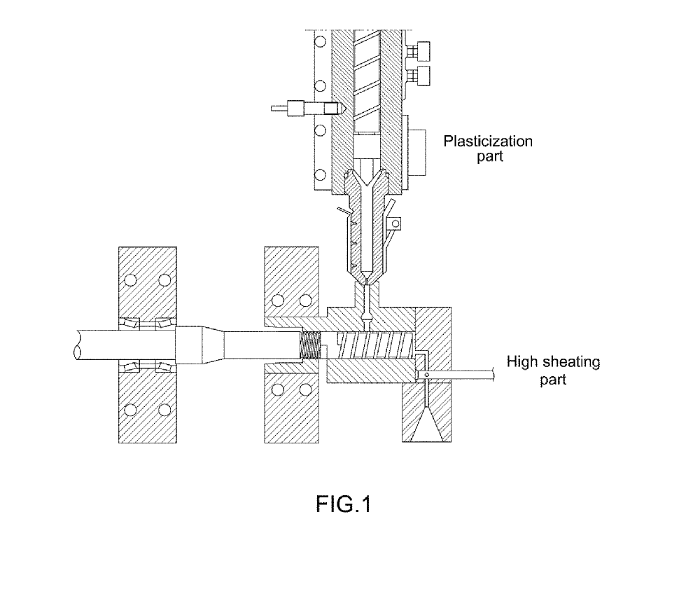

FIG. 1 is a schematic view of a high shearing apparatus that can be used to realize a method of manufacturing a polyamide composite according to an exemplary embodiment of the present invention.

A plasticization part of the high shearing apparatus of FIG. 1 functions to melt and mix a resin and carbon nanotubes and measures a predetermined amount of the molten mixture required for a test. A temperature of the plasticization may be up to 350° C. A high shearing unit is supplied with the resin mixture molten and mixed in the plasticization part and shearing-processes the supplied resin mixture. The High shearing part receives the resin mixture measured and molten in the plasticization part through an inlet valve. When the mixture is supplied, the High shearing part applies the high shearing to the mixture at a predetermined shear rate and a predetermined processing temperature in a state where the inlet valve is closed, after that the mixture is discharged to an external side through an outlet valve.

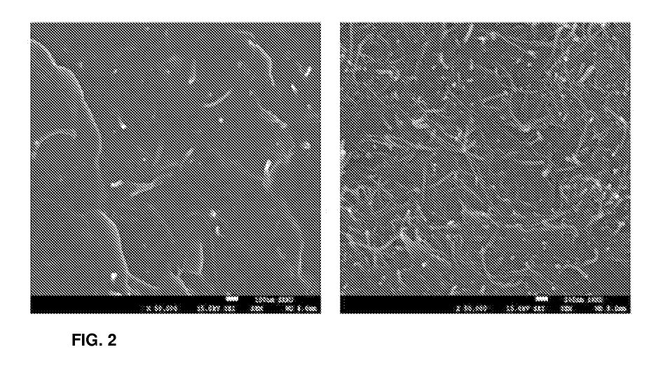

FIG. 2 is a SEM picture showing a dispersion state of the carbon nanotubes after a molten mixture of polyamide6 and multi wall carbon nanotubes are processed at a low shearing rate (left side, 440 sec⁻¹) and at a high shearing rate (right side, 4400 sec⁻¹). As shown in FIG. 2, the dispersion of the carbon nanotubes is remarkably low in the low shearing rate due to shortage of the shearing force.

According to an exemplary embodiment of the present disclosure, the invention provides a method of manufacturing a carbon nanotube composite of polyamide6 by applying a high shearing force to a mixture of a molten resin and carbon nanotubes. A general carbon nanotube has a multi-layer structure providing a strong coupling force that remains between the layers by static electricity and van der Waals forces. In order for the mixture of the resin and carbon nanotubes to exhibit its desired properties, the nano-sized carbon nanotubes should be uniformly distributed in the resin. To this end, various methods are used. For example, a method for weakening the static electricity or van der Waals forces, a method for enhancing affinity between the carbon nanotubes and the resin, or a method for applying shearing force greater than the coupling force of the carbon nanotubes, are used. Generally, the shearing force is represented as σ=ηr, where η indicates viscosity of the resin and r denotes a shearing rate of the resin. When the shearing rate is increased, a higher shearing force can be attained. By applying a higher shearing force to the mixture of the resin and carbon nanotubes, the layered structure of the carbon nanotubes is broken and thus the carbon nanotubes can be uniformly dispersed in the resin to a nano degree.

Polycarbonate (PC) and polymethylmetacrylate (PMMA), being representative immiscible resins, are transparent amorphous resins. However, when mixing the PC and PMMA, the PC/PMMA mixture becomes an opaque resin due to the difference of the refractive index between the PC and PMMA by the immiscible property. However, according to Japanese Patent No. 2009-196196, it is noted that, when the PC/PMMA mixture is processed by applying the high shearing rate, nano dispersion is realized to a degree at which the visible ray can pass, thereby changing the opaque PC/PMMA mixture into the transparent PC/PMMA mixture. This supports that the carbon nanotubes can be dispersed in the polyamide6.

Therefore, according to the preferred embodiments of the present disclosure, by processing a composition of the polyamide6 and carbon nanotubes by applying the high shearing force to the composition, the following effects can be attained.

1) By performing the high shearing process to the simple mixture of the resin and carbon nanotubes, without performing pre-treatment to the carbon nanotubes, the composite can be manufactured without going through additional complicated process steps.

2) The high shearing process can be performed without adding a surfactant, a compatibilizer, a coupling agent, and the like that are generally used in the absence of high shearing rates.

3) By applying the high shearing rate, the mixing can be completed within 5-100 seconds and thus the processing time can be greatly reduced compared with a prior art process requiring dozens of pre-treating hours.

4) As the mixing efficiency is improved by the high shearing process, the mechanical property can be improved using a minimum quantity of carbon nanotubes and thus the weight of the composite can be reduced.

In certain embodiments, the invention provides a method as described above, wherein the resin is an amide resin. In certain embodiments, the amide resin is a molten resin. In certain embodiments, the resin is polyamide 6, polyamide 66, polyamide 46, or polyamide 11. In a preferred embodiment, the resin is polyamide6.

In other embodiments, the invention provides a method as described above, wherein the carbon nanotube is a multi wall carbon nanotube, a single wall carbon nanotube, or a carbon nanofiber, or mixtures thereof.

In various embodiments, the invention provides a method as described above, wherein the nanotube comprises about 0.001% to about 10% weight of the mixed composition. In various embodiments, nanotube comprises about 0.01% to about 5% weight of the mixed composition. In various embodiments, nanotube comprises about 0.01% to about 1% weight of the mixed composition. In various embodiments, nanotube comprises about 0.01% to about 0.5% weight of the mixed composition. In various embodiments, nanotube comprises about 0.01% to about 0.1% weight of the mixed composition. In various embodiments, nanotube comprises about 0.1% to about 1% weight of the mixed composition.

In other embodiments, the invention provides a method as described above, wherein the mixing is performed at a shearing rate ranging from about 600 to about 10,000 sec⁻¹. In certain embodiments, the shearing rate ranges from about 1,000 to about 4,400 sec⁻¹. In certain embodiments, the shearing rate ranges from about 2,000 to about 5,000 sec⁻¹. In certain embodiments, the shearing rate ranges from about 3,000 to about 6,000 sec⁻¹. In certain embodiments, the shearing rate ranges from about 4,000 to about 5,000 sec⁻¹.

In other embodiments, the invention provides a method, wherein the mixing of the polyamide6 composition is performed at a time of about 2 seconds to about 200 seconds. In certain embodiments, the time is about 3 seconds to about 100 seconds. In certain embodiments, the time is about 5 seconds to about 100 seconds. In certain embodiments, the time is about 5 seconds to about 50 seconds. In certain embodiments, the time is about 5 seconds to about 25 seconds.

In other embodiments, the invention provides a method, wherein the mixing of the polyamide6 composition is performed at a temperature of about 100° C. to about 400° C. In certain embodiments, the temperature ranges from about 100° C. to about 200° C. In certain embodiments, the temperature ranges from about 200° C. to about 300° C. In certain embodiments, the temperature ranges from about 220° C. to about 280° C.

Polyamide6 that is dried in hot-air drying machine, which is maintained at a constant temperature of 80° C., for 4 hours or more was well mixed with carbon nanotubes and put into a Plasticization part of a high shearing apparatus (NHSS2-28, Niigata Machine Techno Co. Ltd.), after that the mixture (resin) was molten at 30 rpm and measured. The molten and measured resin was injected into a High shearing part and high shearing was performed under conditions (temperature, staying time, rpm) shown in a below table to manufacture a composite. A flexural property of the composite was measured by ASTM D790 and at a cross head speed of 10 mm/min.

The below table illustrates processing conditions of respective embodiments and comparative examples and results thereof. The results are only exemplary materials for proving the invention and are not intended to limit the invention.

### Examples 1, 2, 3, 12, and 13

Flexural strength variation according to contents of the multi wall carbon nanotubes of 0.01%, 0.05%, 0.1%, 0.5%, and 1.0% under a condition of a high shearing processing temperature of 260° C., a shearing rate of 1,760 sec⁻¹, and a processing time of 15 sec was observed. The flexural strengths for the respective contents were 1,355 Kgf/cm², 1,400 Kgf/cm², 1,456 Kgf/cm², 1,377 Kgf/cm², and 1,355 Kgf/cm² that are respectively increased by 20%, 24%, 29%, 22%, and 20% as compared with neat polymer. Flexural modulus were 37,488 Kgf/cm², 38,380 Kgf/cm², 41,355 Kgf/cm², 36,892 Kgf/cm², and 36,000 Kgf/cm² that were respectively increased by 26%, 29%, 39%, 24%, and 21% as compared with the neat polymer. The results are provided in Table 1 below.

### Example 4

In the high shearing process under a condition of a high shearing processing temperature of 260° C., a shearing rate of 1,760 sec⁻¹, a processing time of 5 sec, and a content of the multi wall carbon nanotubes of 0.1%, the flexural strength was 1,513 Kgf/cm² that was increased by 34% as compared with the neat polymer and the flexural modulus was 28,380 Kgf/cm² that was increased by 29% as compared with the neat polymer.

### Examples 5 and 6

Flexural strength variation according to the processing temperature of 260° C. and 240° C. under a condition of a shearing rate of 2,930 sec⁻¹, a processing time of 10 sec, and a content of the multi wall carbon nanotubes of 0.1% was observed. The flexural strengths for the respective temperatures were 1,603 Kgf/cm² and 1,558 Kgf/cm² that were respectively increased by 42% and 38% as compared with neat polymer. Flexural moduli were 43,140 Kgf/cm² and 41,653 Kgf/cm² that were respectively increased by 45% and 40% as compared with the neat polymer.

### Examples 5, 6, and 8

Flexural strength variation according to the processing temperature of 260° C., 240° C., and 270° C. under a condition of a shearing rate of 2,930 sec⁻¹, a processing time of 10 sec, and a content of the multi wall carbon nanotubes of 0.1% was observed. The flexural strengths for the respective temperatures were 1,603 Kgf/cm², 1,558 Kgf/cm²′ and 1547 Kgf/cm² that were respectively increased by 42%, 38%, and 37% as compared with neat polymer. Flexural moduli were 43,140 Kgf/cm², 41,653 Kgf/cm²′ and 41,058 Kgf/cm² that are respectively increased by 45%, 40%, and 38% as compared with the neat polymer.

### Example 7

In the high shearing process under a condition of a high shearing processing temperature of 260° C., a shearing rate of 2,930 sec⁻¹, a processing time of 80 sec, and a content of the multi wall carbon nanotubes of 0.1%, the flexural strength was 1,389 Kgf/cm² that was increased by 23% as compared with the neat polymer and the flexural modulus was 36,000 Kgf/cm² that was increased by 21% as compared with the neat polymer.

### Examples 9 and 10

Flexural strength variation according to contents of the multi wall carbon nanotubes of 0.1% under a condition of a high shearing processing temperature of 260° C., a shearing rate of 2,500 sec⁻¹, 4,400 sec⁻¹ and a processing time of 5 sec was observed. The flexural strengths for the respective contents were 1,479 Kgf/cm² and 1,455 Kgf/cm² that were respectively increased by 31% and 28% as compared with neat polymer. The flexural moduli were 39,868 Kgf/cm² and 38,678 Kgf/cm² that were respectively increased by 34% and 30% as compared with the neat polymer.

### Example 11

In the high shearing process under a condition of a high shearing processing temperature of 260° C., a shearing rate of 2,930 sec⁻¹, a processing time of 10 sec, and a content of the single wall carbon nanotubes of 0.1%, the flexural strength was 1,694 Kgf/cm² that was increased by 50% as compared with the neat polymer and the flexural modulus was 47,603 Kgf/cm² that was increased by 60% as compared with the neat polymer.

The following table shows the flexural strengths and flexural modulus of the respective examples 1 to 13 when compared with the neat polymer.

TABLE 1

| | | | | | | | | Flexural | | Flexural | |
|---|---|---|---|---|---|---|---|---|---|---|---|
| | | | | | | | | strength | | modulus | |
| | | | | | | | | | Increased | | Increased |
| | | | Plasticization | | High shearing part | | | | ratio | | ratio |
| | | CNT | Part | | | Shearing | Processing | | compared | | compared |
| | CNT | contents | Temperature | | Temperature | rate | time | | with | | with |
| Item | type | (w %) | (° C.) | rpm | (° C.) | (Sec⁻¹) | (sec) | Kg/cm² | Neat | Kg/cm² | Neat |
| Neat | | | | | | | | 1129 | 1 | 29752 | 1 |
| Polymer | | | | | | | | | | | |
| EXAMPLE 1 | MWNT | 0.01 | 260 | 150 | 260 | 1760 | 15 | 1355 | 1.2 | 37488 | 1.26 |
| EXAMPLE 2 | MWNT | 0.05 | 260 | 150 | 260 | 1760 | 15 | 1400 | 1.24 | 38380 | 1.29 |
| EXAMPLE 3 | MWNT | 0.1 | 260 | 150 | 260 | 1760 | 15 | 1456 | 1.29 | 41355 | 1.39 |
| EXAMPLE 4 | MWNT | 0.1 | 260 | 150 | 260 | 1760 | 5 | 1513 | 1.34 | 38380 | 1.29 |
| EXAMPLE 5 | MWNT | 0.1 | 260 | 150 | 260 | 2930 | 10 | 1603 | 1.42 | 43140 | 1.45 |
| EXAMPLE 6 | MWNT | 0.1 | 260 | 150 | 240 | 2930 | 10 | 1558 | 1.38 | 41653 | 1.4 |
| EXAMPLE 7 | MWNT | 0.1 | 260 | 150 | 260 | 2930 | 80 | 1389 | 1.23 | 36000 | 1.21 |
| EXAMPLE 8 | MWNT | 0.1 | 260 | 150 | 270 | 2930 | 10 | 1547 | 1.37 | 41058 | 1.38 |
| EXAMPLE 9 | MWNT | 0.1 | 260 | 150 | 260 | 2500 | 5 | 1479 | 1.31 | 39868 | 1.34 |
| EXAMPLE | MWNT | 0.1 | 260 | 150 | 260 | 4400 | 5 | 1445 | 1.28 | 38678 | 1.3 |
| 10 | | | | | | | | | | | |
| EXAMPLE | SWNT | 0.1 | 260 | 150 | 260 | 2930 | 10 | 1694 | 1.5 | 47603 | 1.6 |
| 11 | | | | | | | | | | | |
| EXAMPLE | MWNT | 0.5 | 260 | 150 | 260 | 1760 | 15 | 1377 | 1.22 | 36892 | 1.24 |
| 12 | | | | | | | | | | | |
| EXAMPLE | MWNT | 1.0 | 260 | 150 | 260 | 1760 | 15 | 1355 | 1.2 | 36000 | 1.21 |
| 13 | | | | | | | | | | | |

### Test Examples 1 and 2

Flexural strength variation according to contents of the multi wall carbon nanotubes of 3.0% and 5.0% under a condition of a high shearing processing temperature of 260° C., a shearing rate of 1,760 sec⁻¹, and a processing time of 15 sec was observed. The flexural strengths for the respective contents were 1,231 Kgf/cm² and 1,197 Kgf/cm² that were respectively increased by only 9% and 10% as compared with neat polymer. Flexural moduli were 38,975 Kgf/cm² and 39,868 Kgf/cm² that were respectively increased by 31% and 34% as compared with the neat polymer.

### Test Example 3

In the high shearing process under a condition of a high shearing processing temperature of 260° C., a shearing rate of 730 sec⁻¹, a processing time of 15 sec, and a content of the multi wall carbon nanotubes of 0.1%, the flexural strength was 1,185 Kgf/cm² that was increased by only 5% as compared with the neat polymer and the flexural modulus was 32,727 Kgf/cm² that was increased by only 10% as compared with the neat polymer.

### Test Example 4

In the high shearing process under a condition of a high shearing processing temperature of 260° C., a shearing rate of 1.760 sec⁻¹, a processing time of 120 sec, and a content of the multi wall carbon nanotubes of 0.1%, the flexural strength was 1,298 Kgf/cm² that was increased by 15% as compared with the neat polymer and the flexural modulus was 32,132 Kgf/cm² that was increased by only 8% as compared with the neat polymer.

### Test Example 5

In the high shearing process under a condition of a high shearing processing temperature of 290° C., a shearing rate of 2.930 sec⁻¹, a processing time of 10 sec, and a content of the multi wall carbon nanotubes of 0.1%, the flexural strength was 1,513 Kgf/cm² that was increased by 34% as compared with the neat polymer but somewhat lower than the case where the processing temperature is 260° C. In addition, the flexural modulus was 39,273 Kgf/cm² that was increased by 32% as compared with the neat polymer but somewhat lower than the case where the processing temperature is 260° C.

### Test Example 6

In the high shearing process under a condition of a high shearing processing temperature of 210° C., a shearing rate of 2.930 sec⁻¹, a processing time of 10 sec, and a content of the multi wall carbon nanotubes of 0.1%, a mechanical load was generated due to the increase of the viscosity of the resin and thus it was impossible to process.

The following table shows the flexural strengths and flexural modulus of the respective test examples 1 to 6 when compared with the neat polymer.

| | | | | | | | | Flexural | | Flexural | |
|---|---|---|---|---|---|---|---|---|---|---|---|
| | | | | | | | | strength | | modulus | |
| | | | | | | | | | Increased | | Increased |
| | | | Plasticization | | High shearing part | | | | ratio | | ratio |
| | | CNT | part | | | Shearing | Processing | | compared | | compared |
| | CNT | contents | Temperature | | Temperature | rate | time | | with | | with |
| Item | type | (w %) | (° C.) | rpm | (° C.) | (Sec⁻¹) | (sec) | Kg/cm² | Neat | Kg/cm² | Neat |
| Neat | | | | | | | | 1129 | 1 | 29752 | 1 |
| Polymer | | | | | | | | | | | |
| TEST | MWNT | 3 | 260 | 150 | 260 | 1760 | 15 | 1231 | 1.09 | 38975 | 1.31 |
| EXAMPLE 1 | | | | | | | | | | | |
| TEST | MWNT | 5 | 260 | 150 | 260 | 1760 | 15 | 1197 | 1.06 | 39868 | 1.34 |
| EXAMPLE 2 | | | | | | | | | | | |
| TEST | MWNT | 0.1 | 260 | 150 | 260 | 730 | 15 | 1185 | 1.05 | 32727 | 1.1 |
| EXAMPLE 3 | | | | | | | | | | | |
| TEST | MWNT | 0.1 | 260 | 150 | 260 | 1760 | 120 | 1298 | 1.15 | 32132 | 1.08 |
| EXAMPLE 4 | | | | | | | | | | | |
| TEST | MWNT | 0.1 | 260 | 150 | 290 | 2930 | 10 | 1513 | 1.34 | 39273 | 1.32 |
| EXAMPLE 5 | | | | | | | | | | | |
| TEST | MWNT | 0.1 | 260 | 150 | 210 | 2930 | 10 | N/A | | N/A | |
| EXAMPLE 6 | | | | | | | | | | | |

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

The contents of all references (including literature references, issued patents, published patent applications, and co-pending patent applications) cited throughout this application are hereby expressly incorporated herein in their entireties by reference.

What is claimed is:

1. A method for manufacturing polyamide-carbon nanotube composites, the method comprising:
mixing a polyamide composition with carbon nanotubes to form a mixed composition;
wherein the carbon nanotubes comprise about 0.01% to about 1% weight of the mixed composition;
wherein the mixing is performed at a shearing rate ranging from about 1,000 to about 4,400 sec⁻¹.

2. The method of claim 1, wherein the carbon nanotube comprises a multi wall carbon nanotube, a single wall carbon nanotube, or a carbon nanofiber, or mixtures thereof.

3. The method of claim 1, wherein the mixing of the polyamide composition is performed at a time of about 5 seconds to about 100 seconds.

4. The method of claim 1, wherein the mixing of the polyamide composition is performed at a temperature of about 220° C. to about 280° C.

5. A polyamide-carbon nanotube composite manufactured in accordance with a method of claim 1.

6. The method of claim 1, wherein the polyamide is polyamide6, polyamide 66, polyamide 46, or polyamide 11.

7. The method of claim 1, wherein the polyamide is polyamide 6.
